(19) United States
(12) Patent Application Publication
(10) Pub. No.: US 2010/0041250 A1
(43) Pub. Date: Feb. 18, 2010

(54) ELECTRICAL CONTACT ARRANGEMENT FOR TELECOMMUNICATIONS AND DATA SYSTEMS TECHNOLOGY

(75) Inventors: Ulrich Hetzer, Berlin (DE); Frank Mossner, Berlin (DE)

Correspondence Address: MERCHANT & GOULD PC, P.O. BOX 2903, MINNEAPOLIS, MN, 55402-0903, US

(73) Assignee: ADC GmbH, Berlin (DE)

(21) Appl. No.: 12/522,950

(22) PCT Filed: Dec. 13, 2007
(86) PCT No.: PCT/EP07/10932

§ 371 Date: Jul. 13, 2009

(30) Foreign Application Priority Data
Jan. 18, 2007 (DE) 10 2007 002 768.2

(51) Int. Cl. H01R 12/00

(52) U.S. Cl. 439/59

(57) ABSTRACT

The invention relates to an electrical contact arrangement (1) for telecommunications and data systems technology, comprising at least one electrical contact (K1) and a printed circuit board (2), the contact (K1) being connected to the printed circuit board (2) both electrically and mechanically. The contact (K1) comprises a contact region (7) on which an electrical contact for contacting the counter-contact is generated. The distance (L el) between the contact region (7) of the contact (K1, K8) and the electrical contact point (K8) for contacting the printed circuit board (2) is shorter than the distance (L mech) between the contact region (7) of the contact (K1, K8) and the mechanical contact point (9) for contacting the printed circuit board (2).

The invention relates to an electrical contact arrangement for telecommunications and data technology in accordance with the preamble of patent claim 1.

Such a contact arrangement is known, for example, by the RF contacts of an RJ45 socket. These RF contacts are mechanically and electrically connected to a printed circuit board. In this case, the RF contacts are sprung in order to produce a sufficiently effective electrical contact despite certain tolerances of the sockets and plugs. For reasons of electrical transmission properties, it is endeavored to select the contacts to be as short as possible. On the other hand, the contacts need to be sufficiently long such that they spring to a sufficient extent to compensate for tolerances and to produce sufficient contact force.

Against the background of this prior art, the invention is based on the technical problem of providing an electrical contact arrangement which has good electrical transmission properties and nevertheless is sufficiently sprung.

The solution to this technical problem results from the subject matter having the features of claim 1. Further advantageous configurations of the invention are given in the dependent claims.

In this regard, the electrical contact arrangement for telecommunications and data technology comprises at least one electrical contact and a printed circuit board, the contact being connected both electrically and mechanically to the printed circuit board, the contact having a contact region on which an electrical contact to a mating contact is produced, the length between the contact region of the contact and the electrical contact point with the printed circuit board being shorter than the length between the contact region of the contact and the mechanical contact point with the printed circuit board. As a result, decoupling between the electrical and the mechanical properties of the contact is achieved such that a sufficient spring effect can be set without the electrical transmission properties being substantially altered. The mechanical contact point is in this case achieved either by a fixed connection by means of adhesive bonding, soldering or the like or else by the contact being fixedly clamped against the printed circuit board.

Preferably, the contact between the electrical contact point and the mechanical contact point is bent back from the printed circuit board.

In a further preferred embodiment, in addition, a further electrical contact point to the printed circuit board is formed via the mechanical contact point. In addition to reasons of redundancy, this further contact point can be used for charging compensation capacitances.

In a further preferred embodiment, the electrical contact is pressed against the printed circuit board under prestress via a comb element. This ensures a sufficient contact force.

In a further preferred embodiment, the printed circuit board is mounted such that it can move in relation to a housing part via a spring-elastic element. This makes it possible for a further part of the required excursion to be distributed and for the mechanical length of the contact to be selected such that it is correspondingly shorter. The spring-elastic element is in this case preferably in the form of an elastomer, rubber element or in the form of a spring, preferably a metal spring.

In a further preferred embodiment, the printed circuit board is mounted fixedly in a second housing part, the second housing part being connected to the first housing part such that it can pivot. This prevents contacts, which are mounted, for example, in the second housing part and are connected via soldered joints to the printed circuit board, from being moved in relation to the printed circuit board as a result of the movement of the printed circuit board, which could otherwise result in the soldered joints being torn away.

In a further preferred embodiment, the second housing part is designed to have at least one receptacle for a cylinder of the first housing part, which receptacles then together form a pivot-bearing arrangement.

In a further preferred embodiment, the electrical contact arrangement is in the form of an RJ45 contact arrangement, at least the two outer contacts being designed to have a mechanical length which is longer than the electrical length. This results in the two outer contacts not being damaged in the case of an RJ11 plug inadvertently being plugged in, since the RJ11 plug does not have any contacts there, but lower-lying housing parts, such that, in the prior art, damage to the contacts often arises.

The invention will be explained in more detail below with reference to a preferred exemplary embodiment. In the figures:

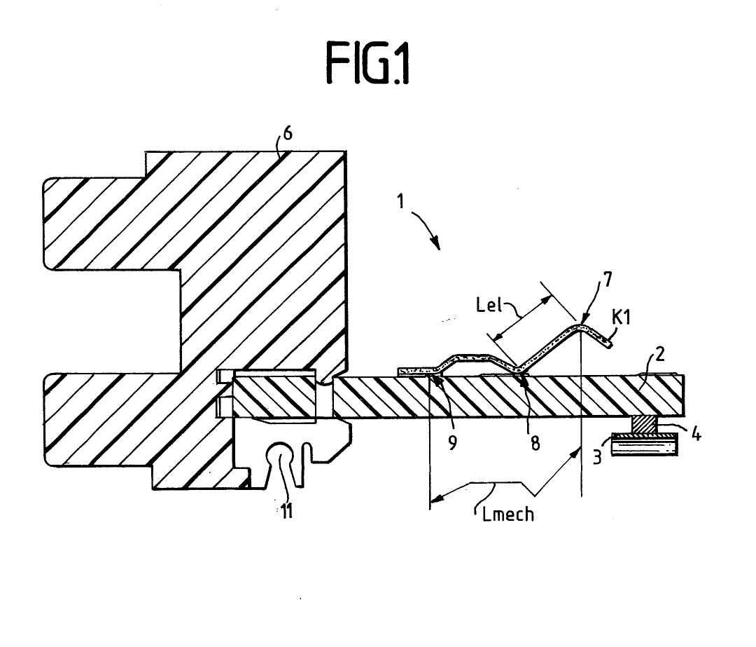

FIG. 1 shows a cross-sectional illustration of an electrical contact arrangement,

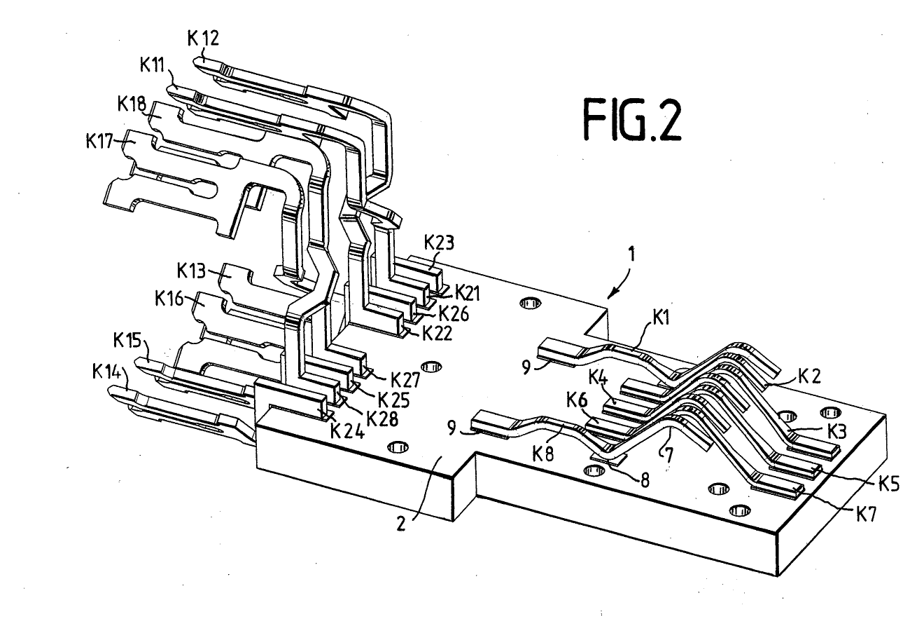

FIG. 2 shows a perspective illustration of an RJ45 contact arrangement, and

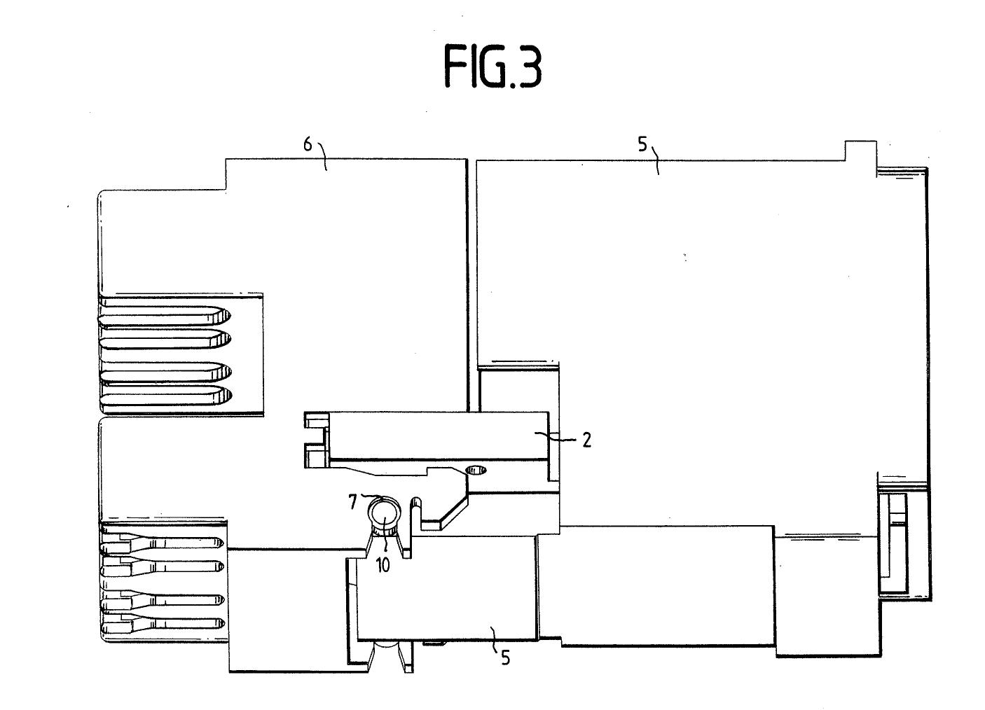

FIG. 3 shows a side view of a first and second housing part.

FIG. 1 illustrates an electrical contact arrangement 1 comprising at least one electrical contact K1, a printed circuit board 2, a contact-pressure spring 3 having an intermediate piece 4 and a second housing part 6. The electrical contact K1 has a contact region 7, an electrical contact point 8 with the printed circuit board 2 and a mechanical contact point 9 with the printed circuit board 2. The printed circuit board 2 is mounted fixedly in the second housing part 6. The printed circuit board 2 is mounted such that it can move in relation to a first housing part 5 (see FIG. 3) and provided with a spring prestress via the contact-pressure spring 3. The second housing part 6 is in this case designed to have a receptacle 11, which accommodates a cylinder of the first housing part 5.

At the mechanical contact point 9, the contact K1 is fixedly connected to the printed circuit board 2, whereas, at the electrical contact point 8, the contact K1 is only pressed against the printed circuit board 2 in a sprung manner. The length L el between the contact region 7 of the contact K1 and the electrical contact point 8 with the printed circuit board 2 is in this case shorter than the length L mech between the contact region 7 and the contact K1 and the mechanical contact point 9 with the printed circuit board 2. If a mating contact, for example in the form of a plug, is now inserted into the first housing part, it generally comes into contact with the contact region 7 of the contact K1 and produces an electrical connection. Owing to the prestress of the electrical contact K1 by a comb element (not illustrated) and the prestress of the printed circuit board 2 by the contact-pressure spring 3, it is ensured here that the contact force between the mating contact and the contact region 7 is sufficiently great if the plug otherwise presses the contact K1 only slightly downwards in the direction of the printed circuit board 2 owing to tolerances. If, however, owing to tolerances or an incorrect plug being incorrectly inserted, the contact K1 is pressed by the plug to a considerable extent downwards in the direction of the printed circuit board 2, this can firstly be compensated for by virtue of the fact that the printed circuit board 2 is pressed downwards counter to the contact-pressure spring 3 and, secondly, the contact K1 absorbs this force by deforming the contact K1 between the electrical contact point 8 and the mechanical contact point 9. The contact-pressure spring 3 and the contact K1 are in this case designed in terms of spring constants such that, at first, the excursion is primarily compensated for by the contact-pressure spring 3. The electrical contact point 8 therefore remains largely uninfluenced and the tolerances of the plug can be compensated for without the quality of the contact to the printed circuit board 2 being influenced. However, if an incorrect plug has been inserted which for example, has a low-lying housing part instead of a mating contact, the contact K1 absorbs this additional excursion by sprung deformation without being destroyed. This results in the electrical contact point 8 of the contact K1 being pushed in the direction of the mechanical contact point 9. In an extreme case, this may result in the electrical contact to the printed circuit board 2 being interrupted, which is not critical, however, since an incorrect plug in any case should not or does not need to come into electrical contact. Otherwise, this would be significant owing to a sufficiently large dimensioning of the contact pad on the printed circuit board 2. Since the electrical transmission properties are largely determined by the electrical length L el, good electrical and mechanical properties are thus achieved at the same time. The part of the contact K1 between the electrical contact point 8 and the mechanical contact point 9 can influence, if need be, the electrical transmission response by means of capacitive couplings.

FIG. 2 illustrates the electrical contact arrangement 1 for an RJ45 socket, this RJ45 socket having eight contacts K1 to K8, which are in the form of RF contacts. In this case, the two outer contacts K1 and K8 are designed to have a longer mechanical length L mech since these two contacts K1 and K8 are at particular risk from an RJ11 plug. As can be seen from the figure, the capacitive coupling of the contact parts between the electrical contact point 8 and the mechanical contact point 9 to other contacts K2 to K7 is low. Furthermore, it can be seen that the contacts K2 to K7 are bent alternately in opposite directions to one another in order to minimize the crosstalk in the contact region 7, since the capacitive coupling is low.

Eight insulation displacement contacts K11 to K18 are arranged on the opposite side of the printed circuit board 2 and are connected electrically to the contacts K1 to K8 via the printed circuit board 2. The insulation displacement contacts K11 to K18 are in this case connected to the printed circuit board 2 via SMD-like contacts K21 to K28. In this case, the connections between the contacts K11, K12, K17 and K18 and the contacts K21, K22, K27 and K28 is slightly longer than between the contacts K13 to K16 and K23 to K26. This results in more pronounced capacitive coupling which is compensated for by the connections being crossed over. In this case, the insulation displacement contacts K11, K12, K17, K18, which belong to the outer contact pairs K1, K2, K7, K8, are preferably the longer contacts in comparison with the contacts K13 to K16, since crosstalk between the outer contact pairs is generally less critical. In this case, express reference will once again be made to the fact that, for example, the contacts K11, K21 and K1 are electrically connected to one another. Likewise, the contacts K12, K22 and K2 etc., i.e. associated contacts, each have the same unit as the index. It can further be seen that the longitudinal direction of the insulation displacement contacts K11 to K18 is parallel to the SMD-like contacts K21 to K28 and the surface of the printed circuit board 2.

It can be seen in FIG. 3 how the first housing part 5 with a cylinder 10 engages in the receptacle 11 of the second housing part 6, with the result that a pivot-bearing arrangement is formed such that the printed circuit board 2 can move in relation to the first housing part 5 and, on the other hand, is rigid with respect to the second housing part 6.

### LIST OF REFERENCE SYMBOLS

1 Contact arrangement
2 Printed circuit board
3 Contact-pressure spring
4 Intermediate piece
5 First housing part
6 Second housing part
7 Contact region
8 Electrical contact point
9 Mechanical contact point
10 Cylinder
11 Receptacle
K1-K8 contacts
K11-K18 Insulation displacement contacts
K21-K28 SMD-like contacts
L el Electrical length
L mech Mechanical length

1. An electrical contact arrangement for telecommunications and data technology, comprising at least one electrical contact and a printed circuit board, the contact being connected both electrically and mechanically to the printed circuit board, the contact having a contact region on which an electrical contact to a mating contact is produced, wherein the length (L el) between the contact region of the contact and the electrical contact point with the printed circuit board is shorter than the length between the contact region of the contact and the mechanical contact point with the printed circuit board.

2. The electrical contact arrangement as claimed in claim 1, wherein the contact between the electrical contact point and the mechanical contact point is designed to be bent back from the printed circuit board.

3. The electrical contact arrangement as claimed in claim 1, wherein, in addition, a further electrical contact point to the printed circuit board is formed via the mechanical contact point.

4. The electrical contact arrangement as claimed in claim 1, wherein the electrical contact is pressed against the printed circuit board under prestress via a comb element.

5. The electrical contact arrangement as claimed in claim 1, wherein the printed circuit board is mounted such that it can move in relation to a housing part via a spring-elastic element.

6. The electrical contact arrangement as claimed in claim 5, wherein the printed circuit board is mounted fixedly in a second housing part, the second housing part being connected to the first housing part such that it can pivot.

7. The electrical contact arrangement as claimed in claim 6, wherein the second housing part is designed to have at least one receptacle for a cylinder of the first housing part.

8. The electrical contact arrangement as claimed in claim 1, wherein the electrical contact arrangement is in the form of an RJ45 contact arrangement, at least the two outer contacts being designed to have a mechanical length which is longer than the electrical length.
